(19) United States
(12) Patent Application Publication
(10) Pub. No.: US 2007/0051265 A1
(43) Pub. Date: Mar. 8, 2007

(54) Method for printing correction

(76) Inventor: Stephan Schultze, Lohr (DE)

Correspondence Address: STRIKER, STRIKER & STENBY, 103 EAST NECK ROAD, HUNTINGTON, NY, 11743, US

(21) Appl. No.: 11/511,935

(22) Filed: Aug. 29, 2006

(30) Foreign Application Priority Data
Sep. 2, 2005 (DE) 10 2005 041 651.9

(51) Int. Cl. B41F 1/34

(52) U.S. Cl. 101/485

(57) ABSTRACT

A method for printing corrections with a register control unit for a multicolor printing press equipped with individual printing stations includes placing printed marks on a printed material, which are detected by sensors, or, in conjunction with an image evaluation occurring in an at least partial print image detection and executing an evaluation in the register control unit in order to control a movement of the printing material or a correction of an element selected from the group consisting of individual printing stations, a web transport, and both in order to compensate for different print lengths among the individual printing stations, printing at least one first printing mark and one second printing mark per product and per printing procedure, and, for register control purposes, comparing the at least one first and second printing marks to reference points or reference regions and/or executing a register control based on a comparison between data which are obtained from a print image detection, and comparison image data.

### CROSS-REFERENCE TO A RELATED APPLICATION

The invention described and claimed hereinbelow is also described in German Patent Application DE 10 2005 041 651.9 filed on This German Patent Application, whose subject matter is incorporated here by reference, provides the basis for a claim of priority of invention under 35 U.S.C. 119(a)-(d).

### BACKGROUND OF THE INVENTION

The present invention generally relates to a method for printing correction.

More particularly, the present invention relates to a method for printing correction with a register control unit for a multicolor printing press equipped with individual printing stations, in which printing marks are placed on the printing material, which are detected by means of sensors or, in conjunction with an image evaluation, an at least partial print image detection occurs and an evaluation is executed in the register control unit in order to control a movement of the printing material or a correction of the individual printing stations and/or a web transport in order to compensate for different print lengths among the individual printing stations.

In multicolor printing in printing presses, particularly in rotary printing presses, the individual colors, in particular cyan, magenta, yellow, and black, are applied in subsequent printing stations. The printing material comes in the form of rolled material and is conveyed endlessly through the printing unit. For the final print quality achieved, it is crucial that the print images of the individual colors be precisely congruent to one another. The congruence of the print images in relation to one another is referred to as the register. In order to align the individual printing stations with one another, in addition to the actual print image, each printing station also prints register measurement marks or general printing marks, for example in the form of register crosses. An optical measurement system can then use these marks for online detection of an offset between the individual print images. Alternatively to the printing of marks, these errors in the print image can be detected by means of a print image detection with image evaluation.

In rotary printing systems, this measurement system is generally a component of the control system, the so-called register control. The register control manipulates the printing process by means of suitable actuators and compensates for register deviations detected by the optical measurement system. In particular, the actuators can change the web length of the printing material between succeeding printing stations so that the print images of succeeding printing stations are congruent to one another.

In addition to the relative position of the printing stations to one another, the causes for deviations between the individual printing procedures include changes in the geometry of the printing material. For example, these geometrical changes are caused by the influence of moisture and by the presence of drying steps between the printing stations. The challenge increases when the printing material is at least partially elastic.

During the printing process, the web tension is kept as uniform as possible, making it possible to achieve favorable printing quality without significant corrections. The control parameters of the register control are adapted to this operating state. But both positive and negative accelerations cause the web tension to change, negatively influencing the register precision. Most often, the control system is unable to sufficiently compensate for this, leading to a corresponding scrap rate in this operating phase. Even after the acceleration phase, the control system needs a certain amount of running time in order to achieve the suitable set values once more. This can also generate scrap.

DE 40 37 728 C1 describes an apparatus for register control of multicolor roller/rotary printing presses according to the web-to-web method, having a controller equipped with a central unit for detecting and storing all control parameters and the control behavior and having a scanning device for detecting web register marks and actuators for controlling the longitudinal register. The apparatus includes a monitoring unit equipped with an acceleration detection unit that detects a speed change in the printing cylinders of the printing press, which deviates from a stable web speed, and has a shut-off device that communicates via signals with the acceleration detection unit and in response to a signal representing this speed change, interrupts the control action until a constant operating speed is achieved once more.

In operations that use flexible dies, the mounting of the die causes a flexing in the material flow direction. This is the case, for example, with flexographic clichés that are flexible in a rubber-like fashion and therefore elastic.

In addition, the modulus of elasticity depends on the cliché thickness, which varies as a function of the pattern to be printed. As a result, a constant elastic force generates a flexing of the cliché in the printing direction on the printing cylinder, which flexing depends on the cliché thickness and therefore the printing pattern. The same phenomenon occurs when the processing dies cannot be produced precisely enough and/or are subjected to powerful production fluctuations within the format. This complicates the task of positioning print images exactly in relation to one another.

Before now, a maximum of one single print correction was executed per format and print. Test prints are measured manually to determine the necessary correction value, which is manually input into the control system. It has turned out, however, that these procedures are not sufficiently precise, particularly in the case of flexible printing clichés.

### SUMMARY OF THE INVENTION

The object of the present invention, therefore, is to create a method for printing correction that compensates for production tolerances in these printing clichés and compensates for errors in the mounting of these printing clichés.

This object is attained in that at least one first printing mark and one second printing mark are printed per product and per printing procedure and, for register control purposes, these are compared to reference points or reference regions and/or the register control is executed based on a comparison between the data, which are obtained from the print image detection, and comparison image data. This method makes it possible to compensate for production tolerances, particularly in the case of flexible printing clichés, and to compensate for errors in the mounting of such printing clichés. It is also possible to effectively correct for distortions that can occur due to varying heights of the clichés.

If additional printing marks are printed per product and per printing procedure and these are evaluated for register control purposes, then this enables better detection and evaluation, even of complex distortions, particularly those that are of a higher order, i.e. nonlinear.

In this connection, the printing material can be divided into a plurality of regions to be evaluated. These can, for example, be a plurality of cliché regions in which the cliché produces a print, i.e. comes into contact with the printing material.

In one variant of the method, the regions to be evaluated are situated within a printing region and/or outside the printing region. This enables a particularly flexible adaptation to the printing patterns.

In a preferred method variant, the printing marks are scanned automatically. This permits an automatic register control in which it is impossible to make corrections to several regions per format.

If the printing marks are detected in an evaluation unit by means of mark readers and/or by means of one or more cameras connected to an image evaluation unit, then in lieu of a fixed number of printing marks, the entire printing region can serve as a correction region so that the rolling-off of the printing die can be pre-distorted in accordance with processing errors of the printing cliché and/or in accordance with mounting errors of the cliché, thus yielding an optimum print on the whole.

In one method variant, the correction is carried out by adapting the position of the printing station for which the respective printing marks or printing image were/was evaluated. This permits an optimum alignment for the next printing procedure.

Alternatively or in addition to this, the correction is carried out by adapting the position of the printing stations that are situated in a material flow direction after the printing station for which the respective printing marks were evaluated. This does not in fact optimize the absolute print. It is advantageous, however, that the different printing stations can be corrected in relation to one another, which is of particular interest in multicolor printing in which, for example, the four basic colors cyan, magenta, yellow, and black must be adjusted very precisely in relation to one another.

In an alternative variant, for correction purposes, the evaluation unit for detecting the printing marks is directly connected to a correcting drive unit embodied in the form of an actuator. This permits a particularly rapid correction.

If the correction is carried out within predeterminable correction regions on the printing material, then this offers the advantage that the correction can be selectively carried out, for example, outside of the printing region. This prevents a “smearing” of the print. It is also possible to shift the correction regions into the printing regions in which a small correction interferes only slightly, thus having only a minimal effect on the printing result.

In a preferred use of the method, the method is used to print paper, cardboard, corrugated cardboard, plastic or metal foil, wood, fabrics, or metals by means of flexible and/or elastic printing clichés. The above-described advantage is achieved for these uses in particular because the problems mentioned at the beginning often occur in these kinds of printing.

If flexographic clichés are used as the printing clichés, which is in particular the case with the direct printing of corrugated cardboard, the correction method can also be used to effectively carry out corrections for distortions that can occur particularly with the use of flexographic clichés.

In another preferred use of the method, when a plurality of printing stations are to be controlled in relation to one another, a first print without correction is initially executed in a first printing station and all of the correction values are checked for possible print length reductions and are modified together with the print of the first printing station in a manner that prevents print length reductions. This is particularly advantageous with regard to the printing of paper or corrugated cardboard in which—in certain cases—critical print length reductions can occur, which can have particularly serious repercussions on the print image. This method variant does not in fact achieve absolute printing precision. But the printing stations remain error-free in relation to one another, without the occurrence of critical print length reductions.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 schematically depicts a movement profile, with and without print length correction,

FIG. 2 schematically depicts a segment of a printing material with two printing marks, and

FIG. 3 schematically depicts a segment of a printing material with a plurality of printing marks.

### DESCRIPTION OF THE PREFERRED EMBODIMENTS

A printing correction according to the prior art is based on the fact that errors in the print lengths are corrected in a printing-free region, through the execution of a correcting movement.

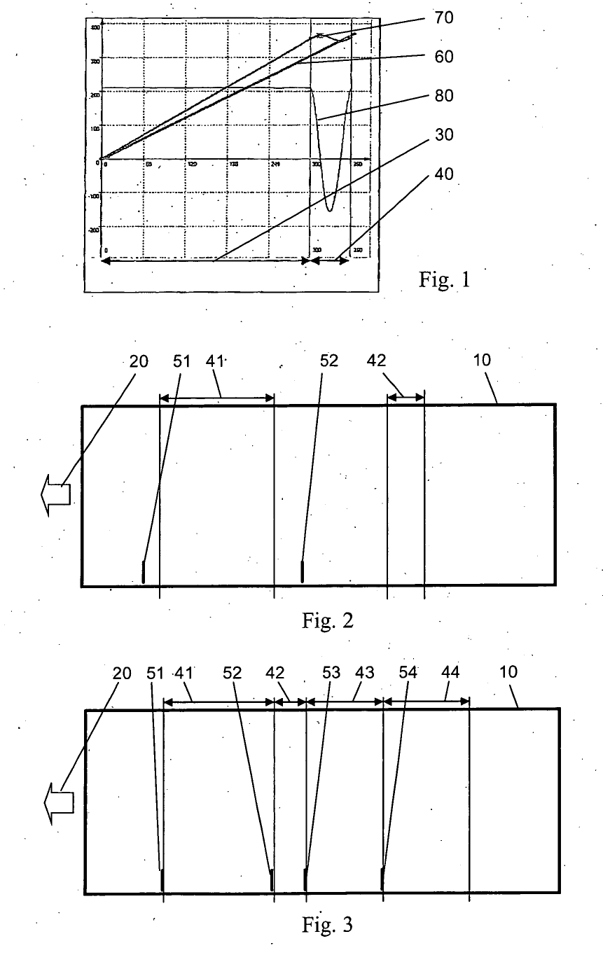

FIG. 1 schematically depicts a movement profile, with and without print length correction. No print length correction yields a movement profile without correction 60. This is depicted by a curve that is linear over its entire range. The speed of a printing material 10 is therefore constant.

A print length correction typically yields a movement profile with correction 70, which, in a printing region 30, has an initially constant speed that is slightly elevated in relation to the movement profile without correction 60. In a correction region 40 that follows the printing region 30, the printing material 10 is first slowed and then accelerated again until the necessary, previously determined print length correction has been achieved. This graph also depicts a corresponding speed profile with correction 80.

Prior automated designs function only with one correction per product and therefore correct only one error per product. As a result, a maximum of one or two print corrections are executed per format. Printing marks of test prints are manually measured to determine the resulting correction value, which is manually input into the control system. Printing marks are generally used for measurable deviations in the print and can also be replaced, for example, by evaluation of a print image. The advantage of printing marks is the ease of measurement.

In the design according to the present invention, additional printing marks are printed per product and per printing procedure and these are compared to reference points or reference regions for register correction purposes. This can occur, for example, through a comparison to a leading axle position. The printing material 10 is divided into a plurality of regions to be evaluated. These can, for example, be a plurality of cliché regions in which the cliché produces a print, i.e. comes into contact with the printing material 10. For example, there are also regions in which the cliché does not come into contact with the printing material 10. It is suitable to carry out corrections in these regions because this prevents “smearing” of the print. There are therefore no repercussions on the transport process of the printing material 10.

If the die is in constant contact with the printing material 10, as is the case, for example, in offset printing, then it is preferable, as regards the image to be printed, to select correction regions in which the correction has a minimal effect on the process and on the printing result. In general, only very slight corrections are possible since otherwise, the correction procedure has negative repercussions on the transport of the printing material 10, e.g. generates fluctuations in web tension.

FIG. 2 schematically depicts an example of a printing material 10 that has a first correction region 41 in the second correction region 42. In the example shown, a first printing mark 51 is situated before the first correction region 41 in a material flow direction 20. Also in the example shown, a second printing mark 52 is situated between the first correction region 41 and the second correction region 42.

FIG. 3 schematically depicts another example. The printing material 10 in this case has a first correction region 41, followed in the material flow direction 20 by a second correction region 42, followed by a third correction region 43, followed by a fourth correction region 44. At the beginning of the first correction region 41, the printing material 10 has first printing mark 51; a second printing mark 52 is printed directly at the beginning of the second correction region 42, a third printing mark 53 is printed directly at the beginning of the third correction region 43, and a fourth printing mark 54 is printed directly at the beginning of the fourth correction region.

When an image evaluation is used instead of the evaluation of printing marks 51, 52, 53, 54, then in lieu of using a fixed number of correction regions 41, 42, 43, 44, it is possible to use the entire printing region 30 as a correction region 40, thus making it possible, through the correction movement, to distort the rolling-off of the printing die so as to produce an optimal print result.

Another variant of the method provides a correction of the subsequent printing stations. Instead of correcting the printing station whose print image has been evaluated, it is also possible to correspondingly correct the position of all of the subsequent printing stations. This option can be expanded to include also correcting the printing station that prints the print image to be evaluated, but this only affects the subsequent printing procedure of the next product.

It is possible to achieve a particularly rapid correction if the evaluation unit, for example a mark reader or a camera system, is connected directly to the correcting drive unit, the actuator. But this option cannot be combined with the options of correcting the subsequent printing stations or with the correction of printing stations and subsequent printing stations.

Another option is to optimize the actuation algorithm by means of a control or actuation that acts on the printing station. If a plurality of printing stations are controlled in relation to one another, then it is possible that some of the adjustments result in print length reductions or print length increases. But print length reductions in particular can have very serious repercussions on the print image. Consequently, this option is provided with the following sequence:
It is assumed that first, a print is made in a first station, which is initially printed without correction.
All of the correction values calculated from this are then checked for possible print length reductions, which have a particularly critical effect on the overall print result.
If print length reductions occur, then the print is not executed, but instead, the correction values are modified so that no length reductions occur.

This is not in fact able to achieve absolute printing precision, but the printing stations remain error-free in relation to one another and the critical print length reductions are prevented.

In particular, the above-described method and its variants make it possible to compensate for distortions of the kind that can occur when using flexographic printing clichés for printing paper, cardboard, corrugated cardboard, plastic or metal foil, wood, fabrics, or metals. This makes it possible on the one hand to correct for the production tolerances of printing clichés, which can vary depending on the cliché height, and on the other hand, allows for the correction of possible mounting errors due to a partially varying stretching of the cliché.

It will be understood that each of the elements described above, or two or more together, may also find a useful application in other types of constructions differing from the types described above.

While the invention has been illustrated and described as embodied in a method for printing correction, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for printing corrections with a register control unit for a multicolor printing press equipped with individual printing stations, comprising the steps of placing printed marks on a printed material, which are detected by sensors, or, in conjunction with an image evaluation occurring in an at least partial print image detection and executing an evaluation in the register control unit in order to control a movement of the printing material or a correction of an element selected from the group consisting of individual printing stations, a web transport, and both in order to compensate for different print lengths among the individual printing stations; printing at least one first printing mark and one second printing mark per product and per printing procedure; and, for register control purposes, comparing the at least one first and second printing marks to reference points or reference regions and/or executing a register control based on a comparison between data which are obtained from a print image detection, and comparison image data.

2. A method as defined in claim 1; and further comprising providing additional printing marks per product and per printing procedure; and evaluating the additional printing mark for register control purposes.

3. A method as defined in claim 1; and further comprising dividing the printing material into a plurality of regions to be evaluated.

4. A method as defined in claim 3; and further comprising situating the regions to be evaluated in a position selected from the group consisting of inside a printing region, outside the printing region, and both.

5. A method as defined in claim 1; and further comprising automatically scanning an element selected from the group consisting of the printing marks, the print image, and both.

6. A method as defined in claim 1; and further comprising detecting an element selected from the group consisting of the printing marks, the print image and both in an evaluation unit by an element selected from the group consisting of mark readers, one or more cameras connected to an image evaluation unit, and both.

7. A method as defined in claim 1; and further comprising carrying out the correction by adapting a position of the printing station for which an element selected from the group consisting of the respective printing marks and printing image was evaluated.

8. A method as defined in claim 1; and further comprising carrying out the correction by adapting a position of the printing stations that are situated in material direction after the printing station for which the respective printing marks were evaluated.

9. A method as defined in claim 1; and further comprising, for correction purposes, directly connecting an evaluation unit for detecting the printing marks to a correcting drive unit configured as an actuator.

10. A method as defined in claim 1; and further comprising carrying out the correction within predeterminable correction regions on the printing material.

11. A method as defined in claim 1; and further comprising using the method to print a material selected from the group consisting of paper, cardboard, corrugated cardboard, plastic foil, metal foil, wood, fabrics, and metal by clichés selected from the group consisting of flexible printing clichés, elastic printing clichés, and both.

12. A method as defined in claim 11; and further comprising using flexographic clichés as the printing clichés.

13. A method as defined in claim 1; and further comprising, when a plurality of printing stations are provided which are controllable in relation to one another, initially executing a first print without correction in a first printing station; and checking all correction values thus determined for possible print length reductions and modifying together all correction values with the print of the first printing station in a manner that prevents print length reduction.
